(19) United States
(12) Patent Application Publication
(10) Pub. No.: US 2025/0184440 A1
(43) Pub. Date: Jun. 5, 2025

(54) IMAGING APPARATUS

(71) Applicant: Panasonic Intellectual Property Management Co., Ltd., Osaka (JP)

(72) Inventor: Koichi OTSUKA, Osaka (JP)

(73) Assignee: Panasonic Intellectual Property Management Co., Ltd., Osaka (JP)

(21) Appl. No.: 18/963,863

(22) Filed: Nov. 29, 2024

(30) Foreign Application Priority Data
Dec. 4, 2023 (JP) 2023-204780

(51) Int. Cl. H04N 1/60; G06F 3/0482; G06F 3/04845

(52) U.S. Cl. CPC H04N 1/6027; G06F 3/0482; G06F 3/04845

(57) ABSTRACT

An imaging apparatus includes: an image sensor that captures a subject image to generate image data; a memory that stores a plurality of color grading datasets each defining a correspondence before and after color information in an image is converted; a display that displays a live view screen based on the image data; a user interface including an operation member; and a controller that controls the display according to a user operation on the user interface, wherein the controller causes the display to transition from the live view screen to a selection screen for a color grading dataset, in response to an operation input to the operation member with the display showing the live view screen, the selection screen for the color grading dataset displaying the color grading dataset under selecting among the plurality of color grading datasets according to a user selection on the user interface.

### TECHNICAL FIELD

The disclosure relates to an imaging apparatus that uses color grading dataset such as a lookup table (LUT).

### BACKGROUND ART

JP 7129678 B discloses an imaging apparatus that performs image processing using an LUT. The imaging apparatus includes a user interface that receives a user operation for designating a combination of one of a plurality of first parameter sets corresponding to photo styles different from that of an LUT and at least one or more second parameter sets corresponding to LUTs. JP 7129678 B discloses that a user can get to a selection screen for LUT in the imaging apparatus from a setting menu screen via a setting screen for my photo style and a setting screen for LUT by performing an operation on each screen.

### SUMMARY

The disclosure provides an imaging apparatus in which color grading dataset can be readily applied to an image according to user's preference.

An imaging apparatus according to the disclosure includes: an image sensor that captures a subject image to generate image data; a memory that stores a plurality of color grading datasets each defining a correspondence before and after color information in an image is converted; a display that displays a live view screen based on the image data; a user interface including an operation member; and a controller that controls the display according to a user operation on the user interface, wherein the controller causes the display to transition from the live view screen to a selection screen for a color grading dataset, in response to an operation input to the operation member with the display showing the live view screen, the selection screen for the color grading dataset displaying the color grading dataset under selecting among the plurality of color grading datasets according to a user selection on the user interface.

According to the imaging apparatus of the disclosure, color grading dataset can be readily applied to an image according to user's preference.

### BRIEF DESCRIPTION OF DRAWINGS

FIG. 1 is a block diagram illustrating an example configuration of a digital camera according to a first embodiment;

FIG. 2 is a view illustrating a back face of a digital camera;

FIG. 3 is a diagram for explaining a photo style and an LUT;

FIG. 4 is a diagram illustrating an example of LUT setting information;

FIG. 5 is a diagram illustrating an example of a data structure stored in a flash memory of the digital camera according to the first embodiment;

FIG. 6 is a flowchart for explaining an example of a method for setting a base photo style in the digital camera according to the first embodiment;

FIGS. 7A to 7D are diagrams illustrating an example display of menu setting of an LUT applicable mode in the digital camera;

FIGS. 8A to 8C are diagrams illustrating an example display of an operation using an LUT button of the digital camera; and

FIG. 9 is a flowchart illustrating an operation using the LUT button of the digital camera.

### DETAILED DESCRIPTION

Hereinafter, embodiments will be described with reference to the drawings as necessary. However, unnecessarily detailed description may be omitted. Note that, the accompanying drawings and the following description are provided for those skilled in the art to fully understand the disclosure, and are not intended to limit the subject matter described in the claims.

### First Embodiment

### 1. Configuration

### 1-1. Hardware Configuration

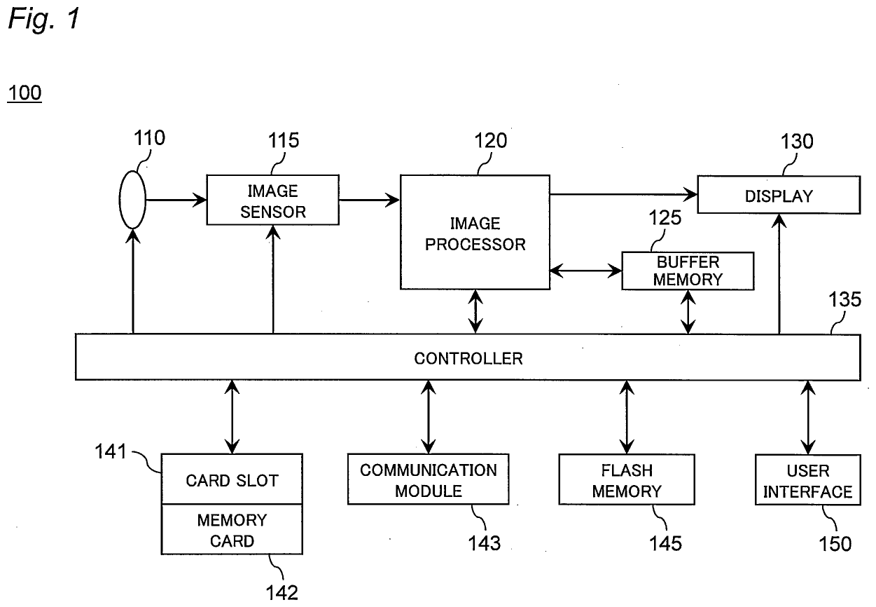

FIG. 1 is a block diagram illustrating an example configuration of a digital camera 100 according to a first embodiment of the disclosure. The digital camera 100 captures a subject image to generate image data. The image data generated by the digital camera 100 includes moving image data and still image data.

The digital camera 100 causes an image sensor 115 to capture a subject image formed via an optical system 110 and generate original image data (RAW data). An image processor 120 performs various kinds of processing on the RAW data generated by the image sensor 115 to generate image data. A controller 135 records the image data generated by the image processor 120 in a flash memory 145 or a memory card 142 mounted in a card slot 141. The controller 135 can display (reproduce) the image data recorded in the flash memory 145 or the memory card 142 on a display 130 according to an operation by a user made to a user interface 150.

The optical system 110 includes a focus lens, a zoom lens, an optical camera-shake correction lens (optical image stabilization: OIS), a diaphragm, and a shutter. The various types of lenses included in the optical system 110 may be of any number or of any number of groups.

The image sensor 115 captures the subject image formed via the optical system 110 and generates the RAW data. The image sensor 115 generates image data of a new frame at a predetermined frame rate (e.g., 30 frames/sec). The controller 135 controls a timing of generating the RAW data and an operation of an electronic shutter in the image sensor 115. Note that, the image sensor 115 may be any of various image sensors including a CMOS image sensor, a CCD image sensor, and an NMOS image sensor. The image sensor 115 is an example of an image sensor in the embodiment.

The image processor 120 performs various kinds of processing on the RAW data output from the image sensor 115 to generate image data. In addition, the image processor 120 performs various kinds of processing on image data read from the memory card 142 to generate an image to be displayed on the display 130. Examples of the various kinds of processing include, but not limited to, white balance correction, gamma correction, Y/C conversion processing, electronic zoom processing, compression processing, decompression processing, and image processing using a lookup table (LUT). The image processor 120 may include a hard-wired electronic circuit or a microcomputer using a program.

The display 130 is a display device capable of displaying information, for example, a liquid crystal display and an organic EL display. For example, the display 130 displays an image based on the image data processed by the image processor 120. In addition, the display 130 displays a menu screen for the user to check the setting of the digital camera 100.

The controller 135 integrally controls the entire operations of the digital camera 100. The controller 135 may include a processor configured to perform a predetermined function by executing a program. For example, the controller 135 may function by various kinds of processors such as a CPU, an MPU, a GPU, a DSU, an FPGA, and an ASIC. The controller 135 may include one or more processors. In addition, the controller 135 may be provided on one semiconductor chip together with other units such as the image processor 120. Although not illustrated, the controller 135 includes a ROM. The ROM stores various kinds of programs such as that for autofocus control (AF control) executed by the controller 135. In addition, the controller 135 includes a RAM (not illustrated) that serves as a work area for the CPU.

A buffer memory 125 is a recording medium that functions as a work memory for the image processor 120 and the controller 135. The buffer memory 125 functions by a dynamic random access memory (DRAM) or the like.

The memory card 142 is detachably inserted into the card slot 141. The card slot 141 can be electrically and mechanically connected to the memory card 142. The memory card 142 is an external memory having therein a recording element such as a flash memory. The memory card 142 can store data such as an LUT and image data generated by the image processor 120.

A communication module 143 performs data communication according to an existing wired communication standard or wireless communication standard. For example, the digital camera 100 can communicate with a communication network such as the Internet and/or other devices equipped with a Wi-Fi module via the communication module 143. The digital camera 100 may directly communicate with other devices via the communication module 143, or may communicate via an access point.

The flash memory 145 is a nonvolatile recording medium. The flash memory 145 can store various kinds of data such as an LUT, photo style setting information 10, LUT setting information 11, and image data, which will be described later.

The user interface 150 is a general term for user interfaces such as a hardware key and a software key of the digital camera 100, and receives an operation of the user. The user interface 150 includes, for example, a button, a mode dial, a touch panel, and a switch. On receiving an operation of the user, the user interface 150 transmits an operation signal corresponding to the user operation to the controller 135.

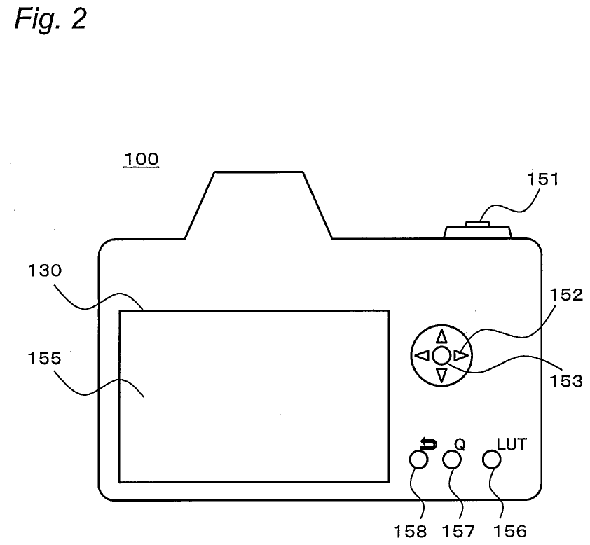

FIG. 2 illustrates, as an example of the user interface 150, a release button 151, a cursor button 152, an enter button 153, a touch panel 155, and a plurality of function buttons (Fn buttons) 156,157, and 158.

The release button 151 is a two-step push button. When the user pushes the release button 151 halfway, the controller 135 performs autofocus control (AF control), auto exposure control (AE control), or the like. When the release button 151 is fully pushed by the user, the controller 135 records image data captured in response to a shooting instruction given by a push operation in the memory card 142 or the like as a recorded image.

The cursor button 152 includes push buttons corresponding to up, down, left, and right. The user can move a selection area, a cursor, or the like displayed on the display 130 by pushing the cursor button 152. The enter button 153 is a push button. It may be configured that when the user pushes the enter button 153 when the digital camera 100 is in a shooting mode or a reproducing mode, the controller 135 displays a menu screen on the display 130. The menu screen is a screen for setting various conditions for image capturing and reproducing.

The Fn buttons 156 to 158 are push buttons to each of which a specific function in the digital camera 100 is assigned. In the embodiment, a case where a function of bringing up an LUT selection screen to be described later is assigned to the Fn button 156 will be described. Hereinafter, the Fn button 156 is also referred to as “LUT button 156”.

The user interface 150 may be configured that operations of various buttons described above are performed not only by physical buttons but also by, for example, virtual buttons displayed on the display 130 receiving a touch operation via the touch panel 155.

### 1-2. Photo Style and LUT

The digital camera 100 has a plurality of shooting modes prepared in advance so that an image can be easily captured with a color tone and image quality that the user prefers. Hereinafter, the shooting mode is referred to as “photo style”. Furthermore, the digital camera 100 of the embodiment is configured that an LUT for color grading that is imported from external according to the user's preference, for example, can be applied to each photo style.

### 1-2-1. Photo Style

When a certain photo style is selected in the digital camera 100, various parameters are set to generate an image having an effect indicated by the photo style. Specifically, values of parameters such as contrast, highlight, shadow, saturation, color tone, hue, filter effect, granularity, sharpness, and noise reduction are set for each photo style to obtain the effect indicated by the photo style. As described above, each photo style is an image adjustment parameter set for adjusting an image presented by the RAW data.

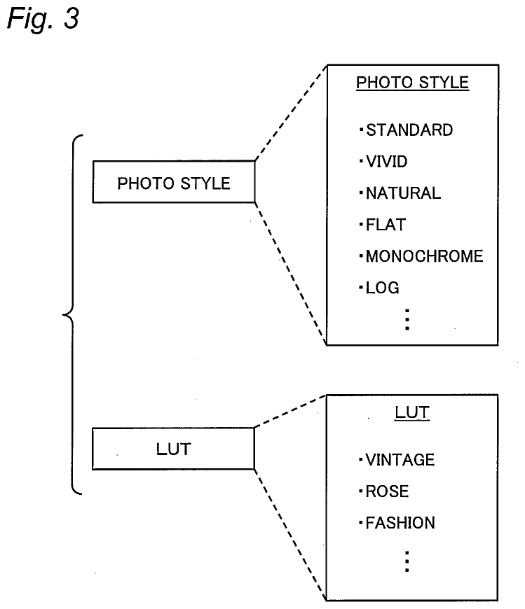

As illustrated in FIG. 3, photo styles such as “standard”, “vivid”, “natural”, “flat”, “monochrome”, and “Log” are prepared in the digital camera 100. “Standard” is a standard setting, and “vivid” is a mode having a vivid effect with relatively high saturation and contrast. “Natural” is a mode having a soft effect with relatively low contrast. “Monochrome” is a mode having a monochromatic effect with no hue. When the photo style is “real-time LUT” to be described later, the image adjustment parameter set described above may include density related to application of the LUT.

“Log” is a mode for capturing an image using a logarithmic-curvilinear gamma curve in which a dynamic range of an imaging element is widely used, and is also referred to as Log gamma (hereinafter referred to as “Log image”). “Flat” is a mode using a flat gamma curve instead of Log gamma, and has an effect of suppressed exaggeration as compared with other photo styles.

### 1-2-2. LUT

For example, an LUT is downloaded from a server by an information processing apparatus and stored in advance in the flash memory 145 of the digital camera 100.

The LUT is an array (parameter set) that defines a correspondence between color information before conversion and color information after conversion of each pixel in an input image. The LUT is, for example, a three-dimensional lookup table indicating relationship between input color data and output color data indicating combinations of three colors of RGB. With reference to the LUT, the image processor 120 performs image processing of converting the color of input image data into the color of output image data.

In the digital camera 100, for example, as illustrated in FIG. 3, names such as “vintage”, “rose”, and “fashion” can be set in the LUT in accordance with hue, theme, creator's intention, and the like of the output image data.

When the user wants to create a unique LUT, it is easier to create a LUT from a standard or the like than to attempt color correction from the hue of a Log image having low saturation and contrast. The effect of color correction is better recognizable when color correction is made from a hue close to a color recognized by a person seeing a subject through naked eyes. Therefore, a unique LUT available in the digital camera 100 allows the user to readily create an LUT that matches the user's preference and to use the LUT.

1-2-3. Selection of Photo Style to which LUT is Applied

Currently distributed LUTs are generally created for application to a Log image. A user can acquire an LUT for a Log image for free on the Internet, for example, or buy an LUT from a seller such as an image processing expert, and import the LUT into the digital camera 100.

To avoid the user sticking to a fixed idea that an LUT applicable to image data must be that for a Log image, the digital camera 100 of the embodiment provides options for the user to combine an LUT with a preferred photo style as illustrated in FIG. 3.

For example, the user can create an LUT for a desired photo style among those including “standard”, “vivid”, “natural”, “flat”, and “monochrome”, and store the LUT in the flash memory 145 via the memory card 142 or the like. As a result, for example, an LUT not for a Log image but for a standard image can be applied to an image having the effect indicated by the photo style of “standard”.

In order to apply an intended LUT to an image having intended image quality, the image having the image quality intended by the user needs to be set, at the time when the LUT is applied, as a base image to which the LUT is applied. For example, when the user wants to apply an LUT for a standard image to an image having the effect indicated by the photo style of “standard”, “standard” needs to be selected in advance as a photo style serving as a base for applying the LUT (hereinafter, referred to as “base photo style”) at the time when the LUT is applied.

A method of selecting a base photo style before applying an LUT is manually selecting, by the user, an appropriate base photo style corresponding to the LUT to be applied. However, to carry out this method, the user needs to memorize the base photo style for each LUT and set the base photo style before applying the LUT. When the user has not memorized the base photo style or fails to set the base photo style, an image intended by the user may not be obtained.

The digital camera 100 of the embodiment automatically selects a base photo style according to the LUT selected by a user operation, and applies the selected LUT and the base photo style to image data. As a result, even when the user has not memorized the base photo style or fails to set the base photo style, the digital camera 100 can readily obtain an image intended by the user.

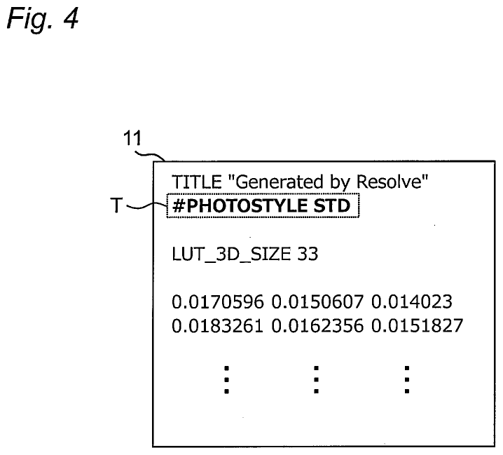

To enable such selection of base photo style, in the embodiment, the LUT setting information 11 which is an LUT file such as a cube file in which an LUT is written includes designation information for designating a base photo style. FIG. 4 is a diagram illustrating an example of the LUT setting information 11. In the LUT setting information 11 in FIG. 4, a tag T is written as an example of the designation information for designating a base photo style. Details of the tag T will be described later.

### 1-2-4. Data Structure

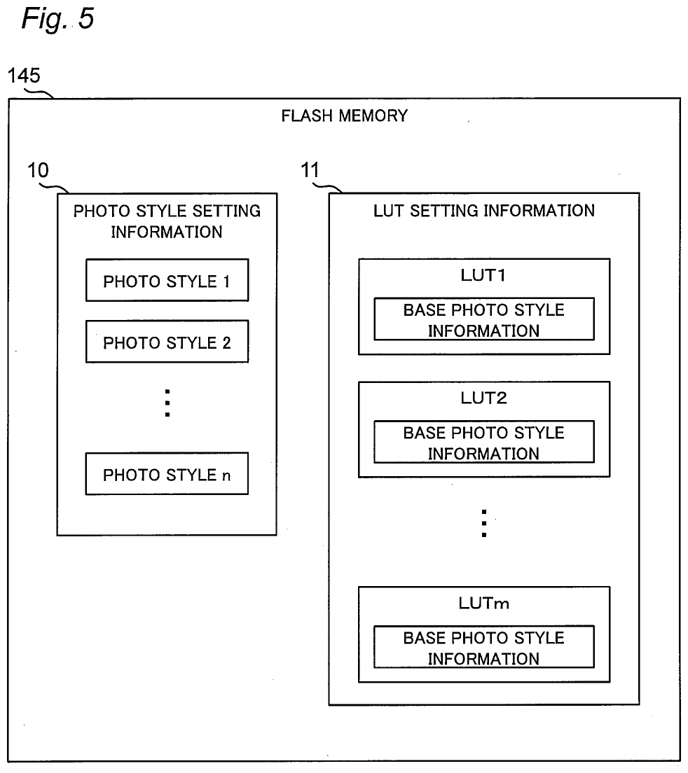

FIG. 5 is a diagram illustrating an example of a data structure stored in the flash memory 145 of the digital camera 100 according to the embodiment. In the flash memory 145, setting information related to photo style and setting information related to LUT are managed as the photo style setting information 10 and the LUT setting information 11, respectively.

In FIG. 5, the photo style setting information 10 includes setting information related to one or more (n) photo styles. The LUT setting information 11 includes setting information related to one or more (m) LUTs.

As illustrated in FIG. 5, setting information related to each LUT in the LUT setting information 11 includes base photo style information as an example of the designation information for designating the base photo style. The base photo style information is written as the tag T illustrated in FIG. 4 in a text file describing the LUT setting information 11.

“#PHOTOSTYLE STD” illustrated as the tag T in FIG. 4 corresponds to the photo style of “standard”. When “#PHOTOSTYLE STD” is written as the tag T in the text file describing the LUT setting information 11 as illustrated in FIG. 4, the base photo style information designates “standard” as the base photo style.

As other tags T, for example, “#PHOTOSTYLE VIVD” corresponds to the photo style of “vivid”, “#PHOTOSTYLE NAT” corresponds to the photo style of “natural”, “#PHOTOSTYLE FLAT” corresponds to the photo style of “flat”, and “#PHOTOSTYLE MONO” corresponds to the photo style of “monochrome”. These tags T are examples. A search tag may include various character strings, numerical values, and symbols.

### 2. Operation

### 2-1. Setting Operation of LUT and Base Photo Style

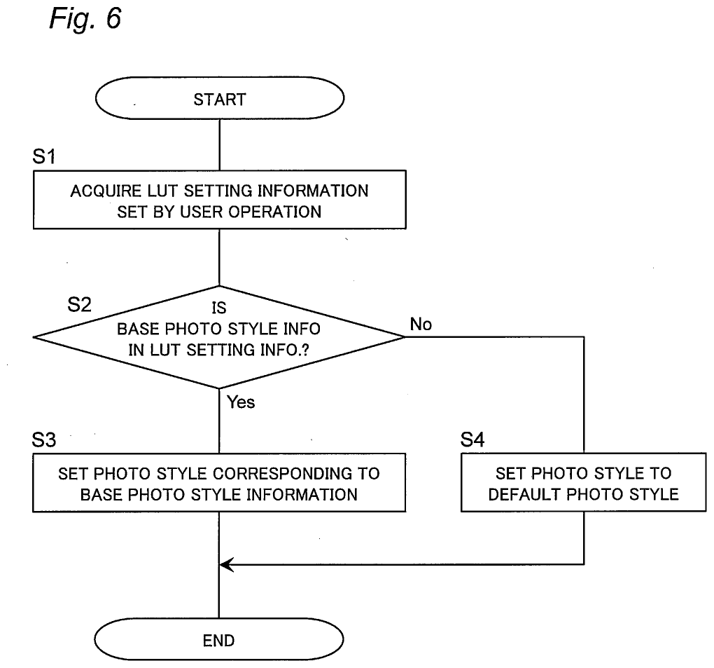

In the digital camera 100, setting and selection of LUT described above can be readily performed by the user using the display 130 and the user interface 150. In addition, in the digital camera 100, the controller 135 automatically selects a base photo style which is the base of the selected LUT. With reference to FIGS. 6, an example method of setting LUT and base photo style in the digital camera 100 will be described.

FIG. 6 is a flowchart for explaining an example method of setting a base photo style in the digital camera 100 according to the embodiment. Each processing illustrated in the flowchart in FIG. 6 is performed by the controller 135.

The user can set the LUT setting information 11 by selecting a desired LUT using the user interface 150. The controller 135 acquires the LUT setting information 11 set by a user operation (S1).

The controller 135 determines whether base photo style information is included in the acquired LUT setting information 11 (S2).

When the base photo style information is included in the LUT setting information 11 (Yes in S2), the controller 135 sets the photo style to the photo style corresponding to the base photo style information (S3). For example, when “#PHOTOSTYLE STD” is included as the tag T in the LUT setting information 11 as illustrated in FIG. 4, the controller 135 sets the photo style to “standard”.

When the base photo style information is not included in the LUT setting information 11 (No in S2), the controller 135 sets the photo style to a default photo style (S4). The default photo style is “Log”, for example, but is not limited thereto, and may be set to any photo style. Step S2 is not limited to the above. For example, also when the controller 135 cannot recognize the base photo style because the base photo style is not installed in the digital camera 100, the process proceeds to No.

### 2-1-1. Menu Setting of LUT Applicable Mode

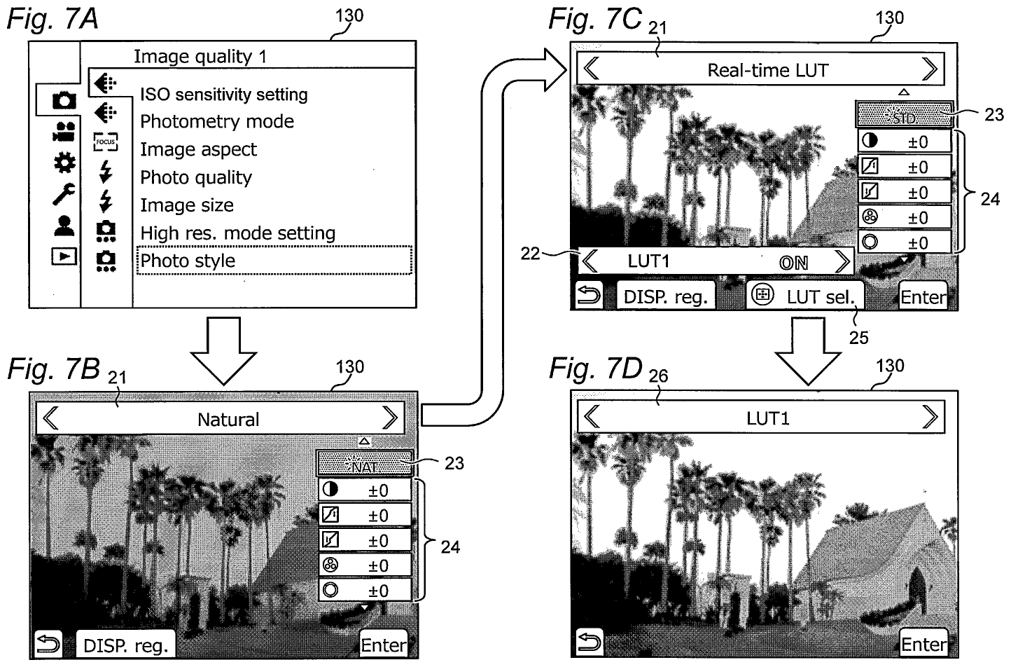

In the embodiment, the digital camera 100 provides, for example, a mode in which an LUT can be applied to an image captured in real time (i.e., an LUT applicable mode) as one of a plurality of photo styles selectable by the user. The menu setting for the LUT applicable mode in the digital camera 100 will be described with reference to FIGS. 7A to 7D.

FIG. 7A illustrates a setting menu screen of the digital camera 100. FIGS. 7A to 7D are examples of display screens displayed in series on the display 130 of the digital camera 100 during setting of the LUT setting information 11 in step S1 in FIG. 6.

For example, the user can use the setting menu illustrated in FIG. 7A to change various kinds of setting in the digital camera 100. In the example, the digital camera 100 displays various setting items such as “photo style” on the display 130, and receives a user operation of selecting various setting items by the user interface 150. FIG. 7B illustrates a setting screen that is brought up when the setting item “photo style” is selected in FIG. 7A.

FIGS. 7B and 7C illustrate photo style setting screens. FIG. 7B illustrates a preset photo style of “natural”. On the setting screen in FIG. 7B, a photo style selection menu 21 for selecting a photo style, a photo style display 23, a parameter display 24, and the like are displayed.

In the photo style selection menu 21, a text or a figure corresponding to a photo style which is a candidate to be selected is displayed. For example, in the photo style selection menu 21, a text indicating a photo style of a candidate to be selected, such as “standard” or “vivid”, is displayed. As illustrated in FIG. 7B, the currently set photo style is displayed on the photo style setting screen that is presented just after transition from the setting menu screen in FIG. 7A.

FIG. 7C illustrates a photo style setting screen in which the photo style has changed from FIG. 7B by a user operation. For example, in the digital camera 100, the photo style of the candidate to be selected can be changed by the user pushing the cursor button 152 for the left-right direction, and determines the photo style to be applied by the user pushing the enter button 153. On the setting screen in FIG. 7C, in addition to various displaying of 21, 23, and 24 on the setting screen in FIG. 7B described above, an LUT switching menu 22 and an LUT selection button 25 are displayed.

In the example in FIG. 7C, “real-time LUT” is displayed in the photo style selection menu 21. The “real-time LUT” is the name of a photo style in the LUT applicable mode provided to the user as one type of photo style in which the user can apply a desired LUT. In this photo style, as illustrated in FIG. 7C, the LUT switching menu 22 for switching between ON and OFF of the LUT applicable mode is displayed. Displayed in the LUT switching menu 22 is an LUT file name for specifying the LUT (“LUT1” in FIG. 7C) and a state indicating whether the LUT is currently ON or OFF. The user can switch between ON and OFF of the LUT applicable mode by pushing the cursor button 152 for the left-right direction, for example.

Displayed in the photo style display 23 is a text or a figure indicating a photo style applied to a captured image (“standard” in FIG. 7C). In the embodiment, when the LUT is applied (“ON” in the LUT switching menu 22), the base photo style is automatically selected by the controller 135.

In this case, since the base photo style is automatically selected, the digital camera 100 may disallow the user changing the photo style. In this case, the controller 135 may gray out the photo style display 23 to indicate that the user cannot change the photo style. In FIG. 7C, the photo style display 23 is grayed out.

The parameter display 24 includes, for example, values of various parameters of a photo style described above. For example, the user can input an operation of changing a value of a parameter such as contrast, highlight, shadow, saturation, granularity, sharpness, noise reduction, or density by selecting a desired adjustable parameter and pushing the cursor button 152 for the left-right direction. As well as when the base photo style is a photo style such as “standard”, “vivid”, “natural”, “flat”, or “monochrome”, the user can adjust the value of each parameter when the base photo style is “Log”. Since the changed parameter is reflected in real time on an image displayed on the display screen, the user can change the parameter while checking the effect. In response to such user operations, the controller 135 acquires parameter change information indicating the parameter changed by the user operation.

When the user presses the LUT selection button 25, the controller 135 causes the display screen to transition to the LUT selection screen illustrated in FIG. 7D.

An LUT selection menu 26 is displayed on the LUT selection screen in FIG. 7D. The user can select the LUT by pushing the cursor button 152 for the left-right direction, for example. In the LUT selection menu 26, for example, a desired LUT can be selected by a user operation from a plurality of LUT1 to LUTm (hereinafter also referred to as “LUT library”) in the LUT setting information 11 (FIG. 5) stored in advance in the flash memory 145 of the digital camera 100.

As described above, when the user wants to select the LUT to be applied in the menu setting, the user first performs an operation of changing the screen from the setting menu screen in FIG. 7A to the selection screen in FIG. 7B, and then performs an operation of changing the photo style to the “real-time LUT”. Furthermore, the user needs to change the screen from the setting screen in FIG. 7C to the LUT selection screen in FIG. 7D, and then perform an operation. This series of user operation requires time and effort.

In view of this, the digital camera 100 according to the embodiment is free of such time and effort, since the digital camera 100 includes the LUT button 156 that instantly allows the user to use the LUT that the user want to apply.

### 2-2. Operation Using LUT Button

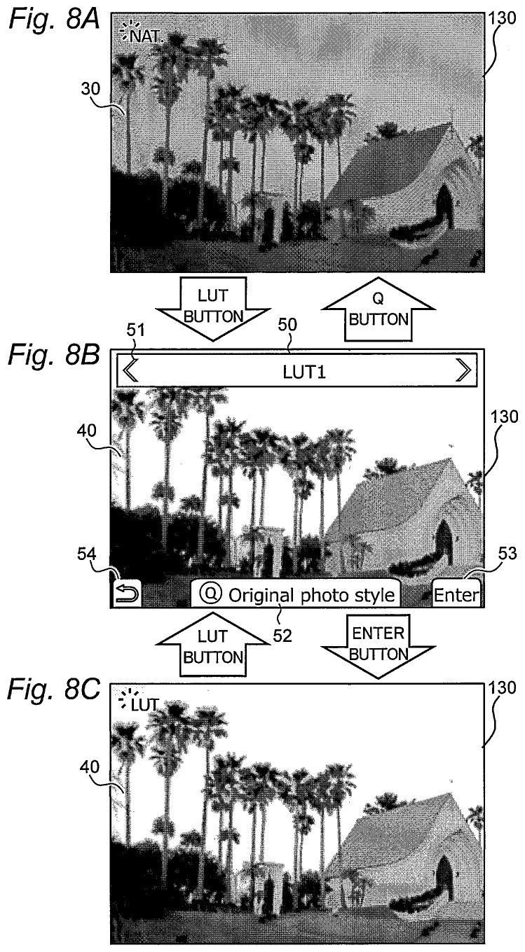

An outline of an operation using the LUT button 156 in the digital camera 100 of the embodiment will be described with reference to FIGS. 8A to 8C.

FIG. 8A illustrates a live view screen of a photo style used before the LUT applicable mode is used in the digital camera 100. FIG. 8B illustrates an LUT selection screen displayed by operating the LUT button 156 of the digital camera 100 according to the embodiment. FIG. 8C illustrates a live view screen in the LUT applicable mode.

FIG. 8A illustrates a shooting standby state in which the photo style that the user of the digital camera 100 is using is not “real-time LUT”. In the example in FIG. 8A, the display 130 shows a live view image 30 in a photo style used with no LUT applied, in particular. In this example, the photo style in use is “natural”.

According to the digital camera 100 of the embodiment, from a mode that is not the LUT applicable mode, as in an example illustrated in FIG. 8A, the user can instantly get to the LUT selection screen as illustrated in FIG. 8B by operating the LUT button 156.

In the embodiment, as illustrated in FIG. 8B, the LUT selection screen presented by operating the LUT button 156 includes an LUT selection field 50, an LUT change button 51, and a live view image 40. The LUT selection field 50 displays the file name of the currently selected LUT. The LUT change button 51 responds to a user operation to change the currently selected LUT by a touch operation, for example. In the LUT selection screen of the embodiment, the currently selected LUT in the LUT selection field 50 is applied to the live view image 40. Furthermore, the LUT selection screen of this example includes a Q button 52, a determination button 53, and a return button 54 (details will be described later).

FIG. 8C illustrates a shooting standby state in which the photo style that the user is using is “real-time LUT”. In the example in FIG. 8C, the display 130 shows the live view image 40 to which the LUT selected and determined by the user is applied. According to the digital camera 100 of the embodiment, the user can instantly get to the LUT selection screen as illustrated in FIG. 8B also from the LUT applicable mode by operating the LUT button 156 as illustrated in FIG. 8C.

According to the digital camera 100 of the embodiment as described above, the LUT button 156 enables instant switching to the LUT applicable mode, skipping the setting of photo style in particular, making it easy to change the selection of LUT from various shooting standby states (FIGS. 8A and 8C). In addition, the digital camera 100 according to the embodiment is operable to receive various user operations via the LUT selection screen (FIG. 8B) as well as by the LUT button 156, so that the user can readily use the LUT applicable mode and the photo styles. Details of operations of the digital camera 100 according to the embodiment will be described below.

### 2-2-1. Details of Operation

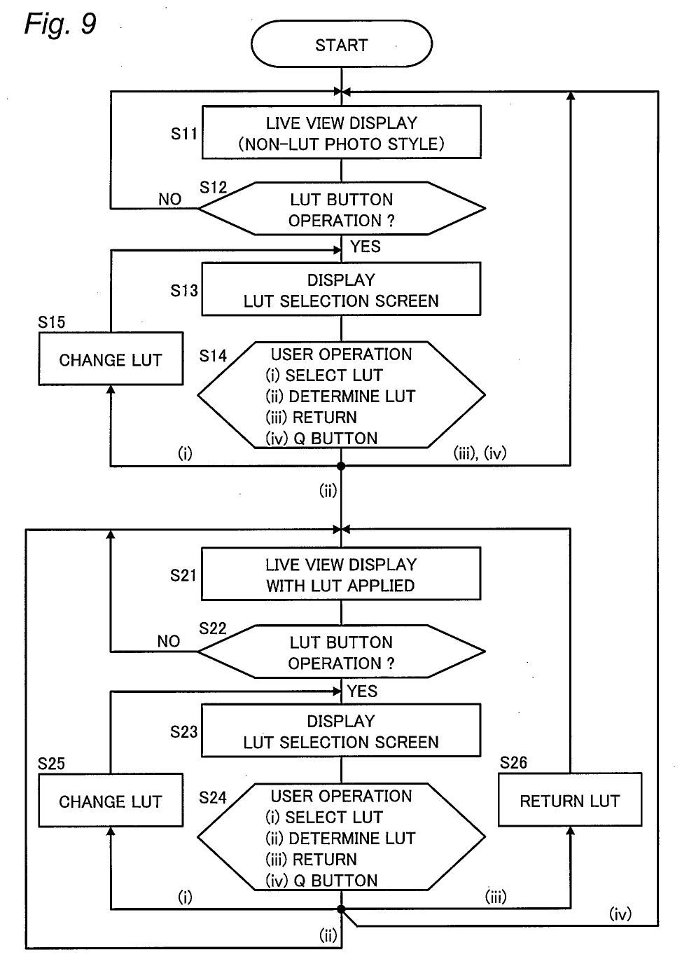

Detail of operations using the LUT button 156 of the digital camera 100 of the embodiment will be described with reference to FIGS. 8 and 9.

FIG. 9 is a flowchart illustrating an operation using the LUT button 156 of the digital camera 100 according to the embodiment. For example, the processing illustrated in the flowchart in FIG. 9 starts from a state in which a photo style different from “real-time LUT” is used in the digital camera 100. For example, the LUT library including a plurality of LUTs is stored in advance in the flash memory 145 of the digital camera 100 before the flow starts.

First, as illustrated in FIG. 8A, the controller 135 of the digital camera 100 displays a live view screen, to which no particular LUT is applied, on the display 130 (S11). For example, based on the photo style setting information 10 (FIG. 5), the controller 135 causes the image processor 120 to perform image processing of applying the photo style in use to an imaging result of the image sensor 115. Accordingly, the live view image 30 for setting image quality of the photo style is generated.

For example, in a state (S11) in which the live view screen that is not in the LUT applicable mode is displayed as described above (FIG. 8A), the controller 135 receives a user operation (S12) of pushing the LUT button 156 (FIG. 2). For example, when the process proceeds to YES in step S12, the controller 135 of the digital camera 100 causes switching to the LUT applicable mode. For example, the controller 135 stores management information indicating the photo style used when the LUT button 156 is operated (YES in S12) in the flash memory 145.

In step S12, the controller 135 may receive a user operation, by the user interface 150, other than an operation made by the LUT button 156. For example, when an operation of changing the photo style is input (NO in S12), the controller 135 refreshes displaying of the live view screen according to the changed photo style (S11). In step S12, an instruction to capture an image may be input, and for example, the controller 135 may output image data of the photo style in use to the memory card 142 or the like via the card slot 141 as a result of image capturing.

When the operation of the LUT button 156 is input (YES in S12), the controller 135 causes the display 130 to transition directly from the live view screen in FIG. 8A to the LUT selection screen as illustrated in FIG. 8B, without displaying any other screens in particular during the transition, for example (S13).

In displaying the LUT selection screen (S13), any one of LUTs in the LUT library of the digital camera 100 is selectively applied. For example, in step S13 performed for the first time, the LUT at a predetermined location (e.g., in the beginning) in the LUT library is used. It may be configured that in a case of an LUT used in the past in the digital camera 100, management information indicating the lastly used LUT is stored in the flash memory 145, and the controller 135 uses the LUT in step S13 executed for the second time onward.

For example, in step S13, the controller 135 controls the image processor 120 to display in the LUT selection field 50 the file name of the LUT to be applied, and applies the LUT to the live view image 40. Referring to the base photo style information (FIG. 5) of the LUT, the image processor 120 performs image processing of the base photo style on image data from the image sensor 115, and further performs image processing of applying the LUT on the base photo style image. The image processor 120 superimposes the LUT selection field 50 and the like on the LUT-applied live view image 40 thus obtained, and outputs a video signal to the display 130.

With the LUT selection screen being displayed (S13), the controller 135 receives various user operations on the LUT selection screen by the user interface 150 (S14). The user operations received in step S14 include (i) LUT selection operation, (ii) LUT determination operation, (iii) return operation, and (iv) Q button operation.
(i) The LUT selection operation is a user operation for changing the currently selected LUT in the LUT selection field 50. For example, this user operation is set as a touch operation of the LUT change button 51 or a push operation of the cursor button 152 for the left-right direction.
(ii) The LUT determination operation is a user operation to instruct determining an LUT from the LUT selection screen. For example, this user operation is set as a touch operation of the determination button 53 or a push operation of the physical enter button 153. The LUT determination operation may be a half-push operation of the release button 151.
(iii) The return operation is a user operation for returning the display screen on the display 130 to the state before transition to the LUT selection screen. For example, this user operation is set as a touch operation of the return button 54 or a push operation of the corresponding Fn button 158.
(iv) The Q button operation is a user operation which is made to end the LUT applicable mode to return to the shooting mode such as a photo style that was selected before switching to the LUT applicable mode. For example, this user operation is set as a touch operation of the Q button 52 or a push operation of the corresponding Fn button 157.

In step S14 of the embodiment, the operation of the LUT button 156 is set invalid (the same applies to S24). That is, even when the user operates the LUT button 156 with the LUT selection screen being displayed, the controller 135 keeps the LUT selection screen (FIG. 8B) with no transition of the display 130 in particular.

When an LUT selection operation is input with the LUT selection screen being displayed ((i) in S14), the controller 135 changes the LUT to be applied to the LUT selection screen according to the input LUT selection operation (S15), to perform processing in step S13 and the subsequent steps again for the changed LUT. Accordingly, on the LUT selection screen displayed in the subsequent step S13, the user can visually check the effect of the newly selected LUT and the like on the live view image 40 to which the LUT is applied.

When the LUT determination operation is input ((ii) in S14), the controller 135 causes the display 130 to transition from the LUT selection screen in FIG. 8B to the live view screen of the real-time LUT as illustrated in FIG. 8C, for example (S21).

In step S21, the controller 135 controls the image processor 120 to apply the same LUT as that applied to the LUT selection screen displayed at the time when the LUT determination operation is performed to the live view image 40. For example, the image processor 120 performs image processing of the base photo style and the LUT similarly to that in step S13, and outputs a video signal of the live view screen in the LUT applicable mode (FIG. 8C) to the display 130.

When the return operation is input ((iii) in step S14) with the LUT selection screen in step S13 being displayed, referring to the management information of the photo style stored in the flash memory 145, the controller 135 performs the processing in step S11 again, for example. Thus, as illustrated in FIGS. 8B and 8A, the display 130 shows again the live view screen of the photo style used before transition caused by the operation of the LUT button 156 in step S12, for example (S11).

When the LUT selection screen is displayed and the Q button operation is input ((iv) in S14), the controller 135 returns the step to the processing in step S11 similarly to the return operation described above ((iii) in S14). Such a live view display of the original photo style (S11) can be performed by storing the management information of the photo style at the time of switching to the LUT applicable mode (YES in S12) in the digital camera 100, for example.

For example, even in a state (S21) in which the live view screen in the LUT applicable mode is displayed as described above (FIG. 8C), the controller 135 receives a user operation of pushing the LUT button 156 as in step S12 (S22). For example, in the LUT applicable mode, that is, when the photo style of “real-time LUT” is used and the user wants to change the LUT to be applied or finish using the mode, the user operates the LUT button 156 (YES in S22). For example, the controller 135 stores management information indicating the LUT at the time when the LUT button 156 is operated (YES in S22) in the flash memory 145.

In step S22, the controller 135 may receive, by the user interface 150 as in step S12, a user operation other than that made by the LUT button 156. For example, when an instruction to capture an image is input by operating the release button 151 (NO in S22), the controller 135 causes the image processor 120 to generate image data by applying the currently selected LUT to an imaging result of the image sensor 115. This imaging result is output to the memory card 142 via the card slot 141, for example. For example, during such image capturing, the display 130 shows the live view screen (FIG. 8C) in the LUT applicable mode (S21).

When the operation of the LUT button 156 is input (YES in S22), the controller 135 causes the display 130 to transition directly from the live view screen in FIG. 8C to the LUT selection screen as illustrated in FIG. 8B without displaying any other screens in particular during the transition, for example (S23). The processing in step S23 is performed similarly to step S13. For example, when performed for the first time, the LUT used when the LUT button 156 is operated (YES in S12) is used in step S23.

In a state in which the LUT selection screen is displayed again in the LUT applicable mode (S23), the controller 135 receives various user operations ((i) to (iv)) on the LUT selection screen by the user interface 150 as in step S14 (S24).

For example, when the LUT selection operation is input ((i) in S24), the controller 135 changes the currently selected LUT as in step S15 (S25), and refreshes displaying of the LUT selection screen according to the result of change (S23).

When the LUT determination operation is input ((ii) in S24), the controller 135 causes the display 130 to display a live view screen to which the LUT selected when the LUT determination operation is made is applied (S21), similarly to (ii) in step S14 (see FIGS. 8B and 8C).

Meanwhile, when the return operation is input with the LUT selection screen in step S23 being displayed ((iii) in step S24), referring to the management information of LUT stored in the flash memory 145, the controller 135 returns the LUT to be applied to the previous LUT, for example (S26). Accordingly, the controller 135 causes the display 130 to transition to the live view screen in the LUT applicable mode in which the LUT has been returned to the LUT applied before the LUT button 156 is operated in step S22 (S21).

When the Q button operation is input with the LUT selection screen being displayed ((iv) in step S24), referring to the management information of the photo style stored in the flash memory 145, the controller 135 returns the step to the processing in step S11, for example. Thus, the screen on the display 130 returns from the LUT selection screen (FIG. 8B) to the live view screen of the photo style used before switching to the LUT applicable mode (FIG. 8A).

According to the above processing, the digital camera 100 of the embodiment allows the user to readily use the LUT applicable mode provided as a photo style of “real-time LUT”, for example. For example, regardless of the photo style in the shooting standby state of the digital camera 100, the user can instantly get to the LUT selection screen in the LUT applicable mode by operating the LUT button 156 (S11 to S13 and S21 to S23).

As illustrated in FIG. 8B for example, the user can select various LUTs on the LUT selection screen ((i) in S14 and S24) and immediately visually check the effect on the live view image 40 (S13 and S23). For example, the user can check the effect of color conversion by the LUT on the live view image 40 at a shooting site according to a shooting scene, and can readily select an LUT of a desired effect.

As described above, the digital camera 100 according to the embodiment readily provides a user experience of, capturing an image while switching among various LUTs according to a scene of shooting with the photo style of “real-time LUT”, for example. Upon the operation in the LUT applicable mode, the digital camera 100 according to the embodiment readily allows obtaining an intended effect of LUT by changing the base photo style of image data as appropriate according to the selected LUT (S15 and S25).

In the digital camera 100 according to the embodiment, the LUT button 156 is disabled with the LUT selection screen being displayed (S14 and S24). Thus, even when the user erroneously operates the LUT button 156 with the LUT selection screen being displayed, the controller 135 can keep the displayed LUT selection screen on the display 130 to ensure stable operability, for example.

As the LUT button 156 causes switching to the LUT applicable mode with skipping the setting of the photo style, the user may not know how to return to the original photo style used before switching to the LUT applicable mode. In the digital camera 100 of the embodiment, on the LUT selection screen presented by switching to the LUT applicable mode by the LUT button 156, the photo style can be returned to the original photo style by the Q button operation ((iv) in S14 and S24). This makes it easy to return to the original photo style when the user finishes using the LUT applicable mode, which allows the user to readily use the LUT applicable mode.

Meanwhile, when the user uses the LUT applicable mode from the setting menu as illustrated in FIG. 7A to 7D, the user has to set a photo style, so that the user may recognize how to return to the original photo style. When the setting menu transitions to the LUT selection screen, the digital camera 100 of the embodiment does not display, in particular, the Q button 52 as illustrated in FIG. 7D, and is not operable to receive the Q button operation for returning to the original photo style described above. Thus, the digital camera 100 having simplified display configuration allows the user to readily use the photo style of “real-time LUT”.

According to the above processing, the image processing of applying LUT is performed using the LUT file stored in the flash memory 145 in the digital camera 100. Accordingly, the processing speed is higher than when the image processing is performed with an LUT read from outside the digital camera 100, and this enables readily obtaining in real time the live view image 40 to which the LUT is applied, for example.

### 3. Effects

As described above, the digital camera 100 as an example of the imaging apparatus according to the embodiment includes the image sensor 115 as an example of the image sensor, the flash memory 145 as an example of the memory, the display 130 as an example of the display, the user interface 150, and the controller 135 as an example of the controller. The image sensor 115 captures a subject image to generate image data. The flash memory 145 stores a plurality of LUTs as an example of a plurality of LUTs each defining a correspondence between color information before conversion and color information after conversion in the image. The display 130 displays the first live view screen based on the image data. The user interface 150 includes the LUT button 156 as an example of the first operation member. The controller 135 controls the display 130 according to a user's operation on the user interface 150. When the first live view screen is displayed on the display 130 and a user operation (an example of the first operation) on the LUT button 156 is input, the controller 135 causes the display 130 to transition from the first live view screen to the LUT selection screen as an example of a screen to select an LUT (see FIGS. 8). As illustrated in FIG. 8B, for example, the LUT selection screen displays the LUT that is currently selected from a plurality of LUTs according to the user's selection on the user interface 150 ((i) in S14 and S24).

According to the digital camera 100 described above, the user can get to the LUT selection screen from the live view screen by operating the LUT button 156, and the LUT can be readily applied to an image according to the user's preference.

In the digital camera 100 of the embodiment, when the LUT selection screen is displayed on the display 130 and an instruction to determine the currently selected LUT is input to the user interface 150 ((ii) in S14 and S24), the controller 135 causes the display 130 to transition from the LUT selection screen to the second live view screen. For example, as illustrated in FIG. 8C, the second live view screen displays the live view image 40 in which image processing of applying the determined LUT is performed on the image data.

According to the digital camera 100 described above, by selecting and determining a desired LUT on the LUT selection screen, the user can get to the live view screen to which the desired LUT is applied. This allows readily applying an LUT to an image according to the user's preference. An example of the instruction to determine the LUT is the LUT determination operation described above, or may be a shooting instruction made by operating the release button 151.

In the digital camera 100 according to the embodiment, when the second live view screen is displayed on the display 130 and a user operation of pushing the LUT button 156 is input (YES in S22), the controller 135 causes the display 130 to transition from the second live view screen to the LUT selection screen (S23). Accordingly, the LUT selection screen can be brought up by the LUT button 156 from the first live view screen as well as from the second live view screen, which allows the user to readily apply the LUT.

In the digital camera 100 according to the embodiment, the controller 135 has a plurality of shooting modes including the LUT applicable mode as an example of a predetermined shooting mode. In the LUT applicable mode, the LUT is applied in the LUT selection screen and the second live view screen (see the views (B) and (C) in FIGS. 8). The first live view screen displays the live view image 30 in a photo style of various kinds. The photo style is an example of a shooting mode that is one among a plurality of shooting modes and different from a predetermined shooting mode (see FIG. 8A). According to the digital camera 100 of the embodiment, the LUT applicable mode can be provided as well as other shooting modes such as photo styles, which allows the user to readily use the LUT applicable mode.

In the digital camera 100 of the embodiment, the user interface 150 further includes the Q button 52 or the corresponding Fn button 157 as an example of the second operation member different from the LUT button 156. When an operation of the LUT button 156 is input in a photo style that is one among a plurality of photo styles and different from the LUT applicable mode (YES in S12), the controller 135 transitions the display 130 to the LUT selection screen to switch to the LUT applicable mode (S13). When the LUT selection screen is displayed on the display 130 and the Q button operation as an example of the second operation is input to the second operation member ((iv) in S14 and S24), the first live view screen is displayed on the display 130 in the photo style that is the photo style used before switching to the LUT applicable mode (S11). Accordingly, when the user uses and then finishes using the LUT applicable mode, the photo style can be returned to that used before using the LUT applicable mode, and thus, the user can readily use the LUT applicable mode as well as other photo styles.

In the digital camera 100 of the embodiment, when the LUT selection screen is displayed on the display 130 and the return operation as an example of the third operation different from the second operation is input to the user interface 150 ((iii) in S14 and S24), the controller 135 causes the display 130 to transition to one of the first and second live view screens displayed before transition to the LUT selection screen (S11 and S21). Accordingly, screen transition to return to the previous screen after transition to the LUT selection screen can be performed if the user wants. This allows the user to readily use the LUT selection screen or the like.

In the digital camera 100 of the embodiment, when the display 130 has transitioned from the first live view screen to the LUT selection screen, the controller 135 causes the display 130 to display the Q button 52 as an example of operational information prompting the second operation (see FIG. 8B). When the display 130 has transitioned from the predetermined menu screen to the LUT selection screen, the controller 135 does not display the operational information for the second operation on the display 130 (see FIG. 7D). Accordingly, the user can readily recognize the LUT selection screen. The menu screen is configured to manage the LUT applicable mode as a type among a plurality of photo styles, for example (see FIGS. 7A to 7D).

In the digital camera 100 of the embodiment, as illustrated in FIG. 8B, for example, the LUT selection screen includes the live view image 40 in which image processing of applying the currently selected LUT to the image data is performed. Accordingly, the user can visually check the effect of the currently selected LUT on the live view image 40 when selecting an LUT. This allows the user to readily apply the LUT.

In the present embodiment, the digital camera 100 further includes the image processor 120 that performs image processing of applying an LUT to image data. Accordingly, the live view image 40 in which the image processing of LUT is performed can be readily obtained in real time in the digital camera 100, which allows the user to readily use the LUT.

In the digital camera 100 according to the embodiment, when the LUT selection screen is displayed on the display 130 and a user operation of pushing the LUT button 156 is input (YES in S22), the controller 135 disallows, for example, transition of the display 130 from the LUT selection screen (S14 and S24). Disabling the LUT button 156 while the LUT selection screen is displayed allows the user to readily use the LUT applicable mode.

### OTHER EMBODIMENTS

As described above, the first embodiment has been described as an example of the art described in the disclosure. However, the art in the disclosure is not limited to this embodiment, and can also be applied to embodiments to which changes, substitutions, additions, omissions, and the like are appropriately made. In addition, a different embodiment can be made by combining the components described in the first embodiment described above. Other embodiments will be described below.

In the first embodiment, the described example operation does not display the Q button 52 when the digital camera 100 has transitioned from the setting menu to the LUT selection screen. In the embodiment, the digital camera 100 may display the Q button 52, like when transition is made by the LUT button 156, to receive the Q button operation for returning the photo style to the original photo style even when the digital camera 100 has transitioned from the setting menu to the LUT selection screen.

In addition, in the embodiments described above, the user operations ((i) to (iv)) made on the LUT selection screen (FIG. 8B) by operating the LUT button 156 of the digital camera 100 have been exemplified. In the digital camera 100 of the embodiment, the user operation on the LUT selection screen is not limited to that described above. For example, as in the LUT switching menu 22 in FIG. 7C, the user interface 150 may receive a user operation to exit the LUT applicable mode and switch to the base photo style.

In the embodiments described above, the example operation in which the digital camera 100 disables the LUT button 156 while the LUT selection screen is displayed has been described. In the digital camera 100 of the embodiment, the LUT button 156 may not be disabled while the LUT selection screen is displayed. For example, the LUT button 156 may receive any one of (i) LUT selection operation, (ii) LUT determination operation, and (iii) return operation.

In the embodiments described above, the Fn button such as the LUT button 156 is described as an example of the first operation member. In the digital camera 100 of the embodiment, the first operation member is not limited to the LUT button 156, and may be an operation member of various kinds in the user interface 150. For example, the first operation member may be a physical button, a dial, a lever, a joystick, or the like, or may be, for example, a virtual button or the like that receives a touch operation by the touch panel 155. In the embodiment, the second operation member is not limited to the Q button 52 or the corresponding Fn button 157, and may be an operation member of various kinds in the user interface 150 like the first operation member described above.

In the embodiments described above, the example in which the LUT library is stored in the flash memory 145 in the digital camera 100 has been described. The embodiment may be configured that a plurality of LUT files is stored in an external recording medium such as the memory card 142, and a list of LUT file names or the like is stored in the digital camera 100. Alternatively, the LUT may be downloaded from an information processing apparatus such as a smartphone to the digital camera 100. In the embodiment, an example of the memory that stores LUTs in the digital camera 100 is not limited to the flash memory 145, and may be the buffer memory 125. For example, the digital camera 100 may sequentially get externally stored LUTs to be applied, and hold the LUTs in the buffer memory 125. In this case, the buffer memory 125 may not hold a plurality of LUTs together at a time. For example, the buffer memory 125 may store a plurality of LUTs by sequentially holding an LUT and erasing the LUT.

In the embodiments described above, the digital camera 100 including the image processor 120 that performs image processing of LUT has been described. In the embodiment, the digital camera 100 may not necessarily include the image processor 120 that performs image processing of applying an LUT. For example, image processing may be performed in an external server. For example, the digital camera 100 according to the embodiment may transmit image data and information of the currently selected LUT to an external server via the communication module 143, and receive as a response the image data resulting from image processing of applying the LUT performed in the external server.

In the embodiments described above, the display 130 is described as an example of the display. In the digital camera 100 of the embodiment, the display is not limited to the display 130, and may be, for example, an electronic view finder (EVF), or an output module that outputs a video signal complying with HDMI (registered trademark) standard or the like.

In the embodiments described above, the digital camera 100 including the optical system 110 has been exemplified. The imaging apparatus of the embodiment may not include the optical system 110, and may be, for example, a camera with an interchangeable lens.

In the embodiments described above, the digital camera has been described as an example of the imaging apparatus, but the imaging apparatus is not limited to the digital camera. The imaging apparatus of the disclosure may be an electronic device (e.g., a video camera, a smartphone, or a tablet terminal) having an image capturing function.

### EXAMPLES OF ASPECTS

Hereinafter, various aspects according to the present disclosure will be exemplified.

A first aspect according to the present disclosure is an imaging apparatus including: an image sensor that captures a subject image to generate image data; a memory that stores a plurality of color grading datasets each defining a correspondence before and after color information in an image is converted; a display that displays a first live view screen based on the image data; a user interface including a first operation member; and a controller that controls the display according to a user operation on the user interface, wherein the controller causes the display to transition from the first live view screen to a selection screen for a color grading dataset, in response to a first operation input to the first operation member with the display showing the first live view screen, the selection screen for the color grading dataset displaying the color grading dataset under selecting among the plurality of color grading datasets according to a user selection on the user interface.

A second aspect is the imaging apparatus according to the first aspect, wherein the controller causes the display to transition from the selection screen for the color grading dataset to a second live view screen, in response to an instruction input to the user interface, for determining the color grading dataset under selecting, with the display showing the selection screen for the color grading dataset, the second live view screen displaying a live view image corresponding to the image data processed on image processing to apply the determined color grading dataset.

A third aspect is the imaging apparatus according to the second aspect, wherein the controller causes the display to transition from the second live view screen to the selection screen for the color grading dataset, in response to the first operation input to the first operation member with the display showing the second live view screen.

A fourth aspect is the imaging apparatus according to the second or third aspect, wherein the controller has a plurality of shooting modes including a predetermined shooting mode, the predetermined shooting mode is to apply the color grading dataset in the selection screen for the color grading dataset and the second live view screen, and the first live view screen displays another live view image provided in a different shooting mode from the predetermined shooting mode in the plurality of shooting modes.

A fifth aspect is the imaging apparatus according to the fourth aspect, wherein the user interface further includes a second operation member different from the first operation member, and the controller causes the display to transition to the selection screen for the color grading dataset to switch to the predetermined shooting mode, in response to the first operation input to the first operation member in the different shooting mode from the predetermined shooting mode in the plurality of shooting modes, and causes the display to transition to the first live view screen in a previous shooting mode, in response to the second operation input to the second operation member with the display showing the selection screen for the color grading dataset, the previous shooting mode being set before switching to the predetermined shooting mode.

A sixth aspect is the imaging apparatus according to the fifth aspect, wherein the controller causes the display to transition to one live view screen of the first or second live view screen, in response to a third operation input to the user interface with the display showing the selection screen for the color grading dataset, the one live view screen being shown before transition to the selection screen for the color grading dataset, the third operation being different from the second operation.

A seventh aspect is the imaging apparatus according to the fifth aspect, wherein the controller causes the display to display operational information prompting the second operation, when the display is transitioned from the first live view screen to the selection screen for the color grading dataset, and does not cause the display to display the operational information for the second operation on the display, when the display is transitioned from a predetermined menu screen to the selection screen for the color grading dataset.

An eighth aspect is the imaging apparatus according to any one of the first to seventh aspects, wherein the selection screen for the color grading dataset includes a live view image corresponding to the image data processed on image processing to apply the color grading dataset under selecting.

A ninth aspect is the imaging apparatus according to any one of the first to eighth aspects, further including an image processor that performs image processing to apply the color grading dataset to the image data.

As described above, the embodiments are described as the exemplification of the technique in the present disclosure. To that end, the accompanying drawings and the detailed description are provided.

Therefore, among the components described in the accompanying drawings and the detailed description, not only the component essential for solving the problem, but also the component not essential for solving the problem may be included in order to exemplify the above technique. Therefore, it should not be recognized that these non-essential components are essential immediately because these non-essential components are described in the accompanying drawings and the detailed description.

In addition, since the above embodiment is for illustrating the technique in the present disclosure, various changes, substitutions, additions, omissions, and the like can be made within the scope of the claims or the equivalent thereof.

The present disclosure can be applied to an imaging apparatus that uses color grading dataset such as an LUT.

1. An imaging apparatus comprising:
an image sensor that captures a subject image to generate image data;
a memory that stores a plurality of color grading datasets each defining a correspondence before and after color information in an image is converted;
a display that displays a first live view screen based on the image data;
a user interface including a first operation member; and
a controller that controls the display according to a user operation on the user interface,
wherein the controller causes the display to transition from the first live view screen to a selection screen for a color grading dataset, in response to a first operation input to the first operation member with the display showing the first live view screen, the selection screen for the color grading dataset displaying the color grading dataset under selecting among the plurality of color grading datasets according to a user selection on the user interface.

2. The imaging apparatus according to claim 1, wherein the controller causes the display to transition from the selection screen for the color grading dataset to a second live view screen, in response to an instruction input to the user interface, for determining the color grading dataset under selecting, with the display showing the selection screen for the color grading dataset, the second live view screen displaying a live view image corresponding to the image data processed on image processing to apply the determined color grading dataset.

3. The imaging apparatus according to claim 2, wherein the controller causes the display to transition from the second live view screen to the selection screen for the color grading dataset, in response to the first operation input to the first operation member with the display showing the second live view screen.

4. The imaging apparatus according to claim 2, wherein
the controller has a plurality of shooting modes including a predetermined shooting mode,
the predetermined shooting mode is to apply the color grading dataset in the selection screen for the color grading dataset and the second live view screen, and
the first live view screen displays another live view image provided in a different shooting mode from the predetermined shooting mode in the plurality of shooting modes.

5. The imaging apparatus according to claim 4, wherein
the user interface further includes a second operation member different from the first operation member, and
the controller
causes the display to transition to the selection screen for the color grading dataset to switch to the predetermined shooting mode, in response to the first operation input to the first operation member in the different shooting mode from the predetermined shooting mode in the plurality of shooting modes, and
causes the display to transition to the first live view screen in a previous shooting mode, in response to the second operation input to the second operation member with the display showing the selection screen for the color grading dataset, the previous shooting mode being set before switching to the predetermined shooting mode.

6. The imaging apparatus according to claim 5, wherein the controller causes the display to transition to one live view screen of the first or second live view screen, in response to a third operation input to the user interface with the display showing the selection screen for the color grading dataset, the one live view screen being shown before transition to the selection screen for the color grading dataset, the third operation being different from the second operation.

7. The imaging apparatus according to claim 5, wherein
the controller
causes the display to display operational information prompting the second operation, when the display is transitioned from the first live view screen to the selection screen for the color grading dataset, and
does not cause the display to display the operational information for the second operation on the display, when the display is transitioned from a predetermined menu screen to the selection screen for the color grading dataset.

8. The imaging apparatus according to claim 1, wherein the selection screen for the color grading dataset includes a live view image corresponding to the image data processed on image processing to apply the color grading dataset under selecting.

9. The imaging apparatus according to claim 1, further comprising an image processor that performs image processing to apply the color grading dataset to the image data.
